(19) United States
(12) Patent Application Publication
(10) Pub. No.: US 2024/0187430 A1
(43) Pub. Date: Jun. 6, 2024

(54) INTERNET OF THINGS SECURITY ANALYTICS AND SOLUTIONS WITH DEEP LEARNING

(71) Applicant: Board of Regents, The University of Texas System, Austin, TX (US)

(72) Inventor: Luke HOLBROOK, Houston, TX (US)

(21) Appl. No.: 17/773,491

(22) PCT Filed: Nov. 2, 2020
(86) PCT No.: PCT/US2020/058505

§ 371 Date: Apr. 29, 2022

Related U.S. Application Data
(60) Provisional application No. 62/929,211, filed on Nov. 1, 2019.

(51) Int. Cl. H04L 9/40; G06N 3/04

(52) U.S. Cl. CPC H04L 63/1425; G06N 3/04; H04L 63/1416

(57) ABSTRACT

Embodiments may provide robust defenses for IoT devices against criminal actions, such as the theft of information and invasion of privacy. A method of detecting anomalous network traffic may perform monitoring an operational IoT network to obtain network traffic data representing events occurring in the monitored operational IoT network, extracting data relating to a plurality of features of the events from the obtained network traffic data, training a machine learning model to classify the events using the extracted data relating to a plurality of features, monitoring additional operation of the operational IoT network to obtain additional network traffic data in the monitored operational IoT network and extracting additional data relating to a plurality of features of the additional events, classifying the additional events using the extracted additional data relating to a plurality of features, and detecting an anomalous event based on the classification of the additional events.

### CROSS-REFERENCE TO RELATED APPLICATIONS

This application claims the benefit of U.S. Provisional Application No. 62/929,211, filed Nov. 1, 2019, the contents of which are incorporated herein in their entirety.

### BACKGROUND

The present invention relates to systems and methods that may provide IoT network security measures against malware that executes at the server level.

Utilization of smart technologies in everyday life has driven projections of the number of IoT devices to increase to over 46 billion by the year 2020. This influx of “smart” devices has already shown major security breaches with Distributed Denial of Service (DDoS) attacks. Since IoT device security is being exploited at a high rate, immediate action is needed to secure the user. Advancements in network security introduce a promising unsupervised machine learning software approach with the ability to detect anomalous network packets. Although these approaches are proving valuable, this is still a new concept for IoT security, especially in regard to deep learning.

Embedded programs typically utilize a flavor of the Linux operating system with the application programs written in the C programming language. IoT devices tend to have lax security, which results from the simplicity of the device itself and lack of an objective protocol in place. An example of common malware is Gafgyt (also known as BASHLIIE). This malware was first introduced in 2014 and infects devices by way of a brute force attack resulting in a massive Distributed Denial of Service (DDoS). With a predefined arsenal of usernames and passwords, the malware attempts to access a local network by randomly choosing an IP address and attempting various username-password combinations until successful. Typically, the malware will hold TCP ports open, sending frames of junk information into the system and sometimes host-defined bash commands.

Another example of common malware is Mirai, which is a virus that attacks networks by creating slave devices or “bots” out of infected devices to flood networks with access requests in an attempt to force a network reset and gain access to the network. Bots spawned by Mirai continuously scan the internet for the IP address of IoT devices. Mirai includes a table of IP address ranges that it will not infect, including private networks and addresses allocated to the United States Postal Service and Department of Defense. The malware then attempts to crack the security of the device by accessing a look-up-table of more than 60 commonly used manufacturer usernames and passwords. Device sluggishness and an increased use of bandwidth are the only symptoms of an infection by this virus, which makes Mirai a highly volatile threat to users. Rebooting the device is a simple way to clear the device of the malware, however, unless the username and password are immediately changed the device will quickly become re-infected. Instead of brute force attacks, several variants of Mirai adapt to device specific characteristics.

Recent attacks by such malware exploit commercial off the shelf IoT devices and demonstrate an immediate need for robust defenses against criminal actions such as the theft of information and invasion of privacy.

### SUMMARY

Embodiments of the present systems and methods may provide robust defenses for IoT devices against criminal actions, such as the theft of information and invasion of privacy. For example, embodiments may provide IoT network security measures against malware that executes at the server level. Embodiments may utilize the assumption that IoT device popularity and Botnet attacks will be the driving factors behind security. Embodiments may provide unsupervised deep learning models to autonomously perform anomaly detection to assist in securing IoT device networks. Specifically, embodiments may include Deep Neural Networks (DNN) to detect anomalous IoT network behavior. Data may be extracted from IoT devices to identify statistical features of normal IoT traffic, then train a DNN to learn that normal behavior. When an anomalous network packet is detected, the deep learning neural network may raise a red flag to indicate a malicious software attack. Extracting the network's statistical information incrementally may provide for more robust and practical IoT applications. The statistical data may be collected at the network interface (i.e. cloud or server). Embodiments may rely on DNN efficiency to deploy the technology in a realistic commercial setting.

For example, in an embodiment, a method of detecting anomalous network traffic may be implemented in a computer system comprising a processor, memory accessible by the processor and storing computer program instructions an data, and computer program instructions to perform monitoring an operational IoT network to obtain network traffic data representing events occurring in the monitored operational IoT network, extracting data relating to a plurality of features of the events from the obtained network traffic data, training a machine learning model to classify the events using the extracted data relating to a plurality of features, monitoring additional operation of the operational IoT network to obtain additional network traffic data representing additional events occurring in the monitored operational IoT network and extracting additional data relating to a plurality of features of the additional events from the obtained network traffic data, classifying the additional events using the extracted additional data relating to a plurality of features, and detecting an anomalous event based on the classification of the additional events.

In embodiments, the plurality of features may comprise at least one of network traffic-related features, statistics-related features, and timing-related features. The network traffic-related features may comprise at least one of protocol type, message type, and message addresses. The network traffic-related features may comprise protocol type, message type, and message addresses. The statistics-related features may comprise at least one of correlation between at least two traffic streams, covariance between at least two traffic streams, root squared sum of at least two variances of traffic stream, root squared sum of at least two means of traffic streams, standard deviation of packet size, and mean deviation of packet size. The statistics-related features may comprise correlation between at least two traffic streams, covariance between at least two traffic streams, root squared sum of at least two variances of traffic stream, root squared sum of at least two means of traffic streams, standard deviation of packet size, and mean deviation of packet size. The timing-related features may comprise at least one of time between repeated messages and time between request messages and response messages. The timing-related features may comprise time between repeated messages and time between request messages and response messages. The plurality of features may comprise network traffic-related features, statistics-related features, and timing-related features. The network traffic-related features may comprise at least one of protocol type, message type, and message addresses. The network traffic-related features may comprise protocol type, message type, and message addresses. The statistics-related features may comprise at least one of correlation between at least two traffic streams, covariance between at least two traffic streams, root squared sum of at least two variances of traffic stream, root squared sum of at least two means of traffic streams, standard deviation of packet size, and mean deviation of packet size. The statistics-related features may comprise correlation between at least two traffic streams, covariance between at least two traffic streams, root squared sum of at least two variances of traffic stream, root squared sum of at least two means of traffic streams, standard deviation of packet size, and mean deviation of packet size. The timing-related features may comprise at least one of time between repeated messages and time between request messages and response messages. The timing-related features may comprise time between repeated messages and time between request messages and response messages. The machine learning model may comprise one of a support vector machine model, a random forest model, and a deep neural network model. The machine learning model may comprise a deep neural network model and the method further may comprise generating a plurality of feature vectors from the extracted data relating to a plurality of features. Training the deep neural network model may comprise minimizing an anomaly score through backpropagation in the deep neural network model. The method may further comprise tuning hyper-parameters of the deep neural network model. The hyper-parameters of the deep neural network model that are tuned may comprise at least one of a number of hidden layers in the deep neural network model, dimensions of the hidden layers of the deep neural network model, batch sizes for training of the deep neural network model, a number of features included in the deep neural network model, a learning rate of the deep neural network model, and number of time steps to back propagate in the deep neural network model. The hyper-parameters of the deep neural network model that are tuned may comprise a number of hidden layers in the deep neural network model, dimensions of the hidden layers of the deep neural network model, batch sizes for training of the deep neural network model, a number of features included in the deep neural network model, a learning rate of the deep neural network model, and number of time steps to back propagate in the deep neural network model. Detecting an anomalous event may comprise determining a prediction error and detecting an anomalous event when the prediction error is greater than a threshold.

In an embodiment, a system for detecting anomalous network traffic may comprise a processor, memory accessible by the processor, and computer program instructions stored in the memory and executable by the processor to perform monitoring an operational IoT network to obtain network traffic data representing events occurring in the monitored operational IoT network, extracting data relating to a plurality of features of the events from the obtained network traffic data, training a machine learning model to classify the events using the extracted data relating to a plurality of features, monitoring additional operation of the operational IoT network to obtain additional network traffic data representing additional events occurring in the monitored operational IoT network and extracting additional data relating to a plurality of features of the additional events from the obtained network traffic data, classifying the additional events using the extracted additional data relating to a plurality of features, and detecting an anomalous event based on the classification of the additional events.

In an embodiment, a computer program product for detecting anomalous network traffic may comprise a non-transitory computer readable storage having program instructions embodied therewith, the program instructions executable by a computer, to cause the computer to perform a method that may comprise monitoring an operational IoT network to obtain network traffic data representing events occurring in the monitored operational IoT network, extracting data relating to a plurality of features of the events from the obtained network traffic data, training a machine learning model to classify the events using the extracted data relating to a plurality of features, monitoring additional operation of the operational IoT network to obtain additional network traffic data representing additional events occurring in the monitored operational IoT network and extracting additional data relating to a plurality of features of the additional events from the obtained network traffic data, classifying the additional events using the extracted additional data relating to a plurality of features, and detecting an anomalous event based on the classification of the additional events.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of an IoT network system according to embodiments of the present systems and methods.

FIG. 2 is an exemplary illustration of a Deep Neural Network (DNN) learning procedure, according to embodiments of the present systems and methods.

FIG. 3 is an exemplary flow diagram of a process of anomalous network traffic detection, according to embodiments of the present systems and methods.

FIGS. 4 is an exemplary illustration of overlaid data features between normal traffic and malicious attack traffic, according to embodiments of the present systems and methods.

FIG. 5 is an exemplary illustration of a classification performance on a Gafgyt dataset, according to embodiments of the present systems and methods.

FIG. 6 is an exemplary illustration of a classification performance on a Mirai dataset, according to embodiments of the present systems and methods.

FIG. 7 is an exemplary block diagram of a computer system, in which processes involved in the embodiments described herein may be implemented.

FIG. 8 is an exemplary block diagram of a network system including IoT devices, according to embodiments of the present systems and methods.

FIG. 9 is an exemplary block diagram of a network system including IoT devices, according to embodiments of the present systems and methods.

FIG. 10 is an exemplary flow diagram of a process of detecting anomalous network traffic, according to embodiments of the present systems and methods.

FIG. 11A is an exemplary block diagram of a communication system, according to embodiments of the present systems and methods.

FIG. 11B is an exemplary block diagram of a core network of the communication system shown in FIG. 11A, according to embodiments of the present systems and methods.

### DETAILED DESCRIPTION

Embodiments of the present systems and methods may provide robust defenses for IoT devices against criminal actions, such as the theft of information and invasion of privacy. For example, embodiments may provide IoT network security measures against malware that executes at the server level. Embodiments may utilize the assumption that IoT device popularity and Botnet attacks will be the driving factors behind security. Embodiments may provide unsupervised deep learning models to autonomously perform anomaly detection to assist in securing IoT device networks. Specifically, embodiments may include Deep Neural Networks (DNN) to detect anomalous IoT network behavior. Data may be extracted from IoT devices to identify statistical features of normal IoT traffic, then train a DNN to learn that normal behavior. When an anomalous network packet is detected, the deep learning neural network may raise a red flag to indicate a malicious software attack. Extracting the network's statistical information incrementally may provide for more robust and practical IoT applications. The statistical data may be collected at the network interface (i.e. cloud or server). Embodiments may rely on DNN efficiency to deploy the technology in a realistic commercial setting.

Embodiments may utilize the autonomous nature of the DNN, which may rely on an implicit ability to determine patterns autonomously, without user intervention. For example, embodiments may identify TP/TN/FP/FN without user intervention. Further, Embodiments may provide for hyper-parameter tuning of the DNN, such as tuning the number of hidden layers in the DNN, tuning the hidden layer dimensions, fixing the batch size of the number of samples the DNN analyzes, identifying a proper learning rate, and modifying the number of time steps to back propagate. Embodiments may autonomously identify important features without pre-identification of such features. Embodiments may be agnostic to the protocol structure, an identify aspects of the protocol structures as important features without limitation as to the protocol or pre-identification of the protocols. Embodiments may utilize temporal aspects of the network traffic as important features without pre-identification of such temporal aspects.

For example, in a hospital at capacity with COVID-19 patients, struggling to keep up with the inflow of new patients, an advantageous hacker might see this as an easy target to virtually hold the hospital's network hostage to extort cyber currency out of the sensitive situation. A way which the hacker can extort the hospital, the hacker would need to find ports along the network where the hospital has IoT devices—such devices as patient monitoring systems, imaging devices, and infusion pumps to name several which might be unsecured and have typical port addresses—connected to the WI-FI infrastructure. This disclosure introduces a cloud-based approach to provide the hospital with a simpler way to identify when a hacker is poking around the IoT devices on the network and alert the hospital IT staff about when anomalous activity is detected. The deep learning algorithms monitoring the hospital specifically would be tuned to the unique flow of the hospital's network.

As another example, this disclosure can apply to the energy sector where natural gas might be manufactured from a coastal region, which requires abundant and robust sensors to maintain appropriate pressures and control settings at all time. The industrial application might have a custom protocol in place for the programmable logic controllers (PLCs) to communicate with the pressure sensors because LINUX based operating systems for IoT devices typically are unsophisticated. Here, an existing solution which follows typical Open Systems Interconnection (OSI) model protocol layering, might be useless. This disclosure proposes a protocol agnostic solution which can “plug-and-play” using a cloud-based architecture such that the plant operator can easily swipe up on their tablet and confirm the security of the devices from a single application.

As a final example, this disclosure can apply to a smart home, which might be what all middle-class individuals strive for, but, is also ripe for extortion from hackers. Most home IoT devices lack sophisticated security measures which lead to easy targets because typical home IoT devices fundamentally provide minimal functionality (i.e., power on/off, connect to WI-FI, etc.). Further, most users simply forget to change default passwords on the devices. A solution from this disclosure would provide a cloud-based application which provides device monitoring for the individuals using an IoT device to monitor their children, doorbells, and home security cameras. This disclosure proposes an application to monitor the IoT devices on the network for anomalous IoT network activity with a deep learning algorithm tuned to the home owner's specific needs.

Ultimately, this disclosure is advantageous over other approaches because this disclosure provides security to various industries by securing networks of IoT devices autonomously, tuning individualized algorithms to specific networks based on the use case, and monitoring network traffic in a network agnostic manner.

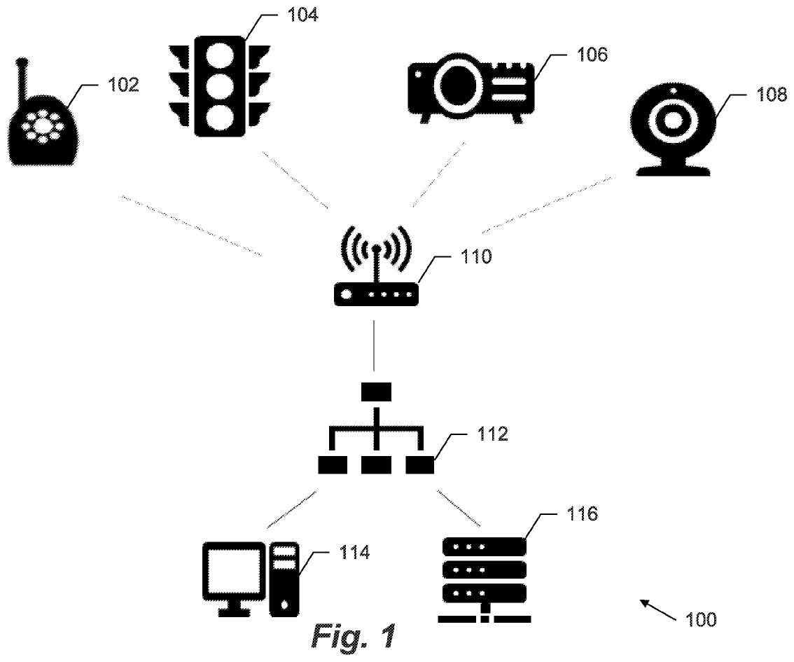

An exemplary IoT network system 100, according to embodiments of the present systems and methods, is shown in FIG. 1. System 100 may include a plurality of IoT devices 102-108, a wireless access point 110, a network switch 112, a user computer system 114, and a server computer system 116. IoT devices may include, for example, personal communications devices 102, such as telephones, etc., utility system devices 104, such as traffic lights, electric meters, etc., display devices 106, such as televisions, projectors, etc., imaging devices 108, such as webcams, etc., as well as other devices not shown in FIG. 1, such as home devices, such as thermostats, doorbells, baby monitors, security cameras, printers, etc., industrial devices, such as oil and gas process monitoring devices, sensor-based tank monitoring devices, acoustic operations monitoring devices, seismic exploration sensors, power management devices, etc., manufacturing devices such as remote gateways, industrial control and supervisory control devices, manufacturing process programmable logic controllers, manufacturing robotics devices, etc., medical devices, such as infusion pumps, imaging systems, ventilators, patient monitors, networked medical equipment, etc., other devices, such as, point-of-sale devices, networked embedded devices, unmanned embedded devices, sparsely manned embedded devices, mobile devices, biological managers, sensory devices, functionality performing devices etc., and any of a large number of other devices.

IoT devices 102-108 typically communicate wirelessly, although wired communications may be provided. For example, IoT devices 102-108 may communicate wirelessly via one or more wireless access points 110. Wireless access point 110 may provide wireless communications between a plurality of wireless devices, such as devices 102-104, and other wired or wireless networks, including, but not limited to public networks, such as the Internet, and private and/or proprietary networks. Typically, such other networks may include one or more network switches 112, which route communication traffic to the appropriate destinations. Among such destinations may be devices such as user computer system 114 and server computer system 116. Typically, server computer system 116 may be the intended destination and/or origin of communication traffic with IoT devices 102-108. In this example, such traffic destined for server computer system 116 may also be sent by network switch 112 to user computer system 114 for monitoring.

### A. Support Vector Machine (SVM)

The optimization objective of Support Vector Machine (SVM) is to maximize the distance between adjacent margins between the separating hyperplane (decision boundary) and the training samples that are closest to this hyperplane. The margin maximization is mathematically analyzed below

w₀+w^{T}xₚₒₛ=1 (1)

w₀+w^{T}x_{neg}=−1 (2)

Subtracting (2) from (1), gives:

w^{T}(xₚₒₛ−x_{neg})=2. (3)

Equation (3) is then normalized by the length of the vector w, defined as:

νw∥=\sqrt{Σⱼ₌₁^{m}wⱼ²}. (4)

This allows for the following:

$$\frac{{w}^{T} ( {x}_{pos} - {x}_{neg} )}{‖ w ‖} = \frac{1}{‖ w ‖} . \qquad ( 5 )$$

The left side of Equation (5) can then be interpreted as the distance between the parallel hyperplanes. This is the targeted margin for maximization. By maximizing the SVM function under the constraint that the samples are classified correctly, the following is concluded:

w₀+w^{T}x⁽ⁱ⁾≥if y⁽ⁱ⁾=1 for i=1 . . . N (6)

w⁰+w^{T}x⁽ⁱ⁾≤if y⁽ⁱ⁾=−1 for i=1 . . . N (7)

where N is the number of samples in the dataset. Equations (6) and (7) declare that all negative samples shall fall on one side of the hyperplane, whereas all the positive samples shall fall behind the opposite side of the hyperplane. This can also be compactly written as follows:

y⁽ⁱ⁾(w₀+w^{T}x⁽ⁱ⁾)≥1∀ᵢ. (8)

Wherever machine learning is utilized to make binary classifications, Support Vector Machines are the most widely used method. Examples can be found in facial detection, written word identification, and in bioinformatics.

### B. Random Forest

The backbone of random forest is the decision tree. This can be understood as a binary decision at each node that are stacked to develop a multi-layered “forest”. The random forest algorithm may be summarized in four steps from:

Draw a random sample from the data of size n (randomly choose n samples from the training set with replacement)

Grow a decision tree from the sample. At each node:

Randomly select d features without replacement

Split the node into random subsets using the feature that provides the best split according to the objective function, for instance, maximizing the information gain

Repeat these steps k times

Aggregate the prediction by each tree to assign the class label by the majority vote.

Random forests are robust since the user does not have to choose proper initial hyperparameter values. The random forest does not need tuning because the model is quite robust to noise from the individual decision trees that make up the forest. A general rule of thumb is the larger the number of trees, the better the performance of the random forest classifier at the expense of an increased computational cost.

Over a given network dataset, a majority vote allows for a weighted and deterministic identification of malicious network traffic. This may compensate for a weak classification by the individual decision trees. The weighted majority is as follows:

ŷ=argmax=Σⱼ₌₁^{m}wⱼχ_{A}(Cⱼ(x)=i) (9)

where wⱼ is a weight associated with the base classifier, Cⱼ, ŷ is the predicted class label of the system, χ_{A} is the characteristic function [Cⱼ(x)=i∈A] and A is the set of unique class labels. For equal weights, (9) can be simplified to:

ŷ=mode{C₁(x), C₂(x), . . . , Cₘ(x)} (10)

where the mode is the most frequent event or result in a set. As an example, the majority vote prediction of a binary classification task would be as follows:

C(x)=sign[Σⱼ^{m}Cⱼ(x)]. (11)

A majority vote will always give more accurate results than when not used, assuming that all classifiers for a binary model have an equal error rate. Additionally, it is assumed that the classifiers are independent, and the error rates are not correlated.

Random forests are a popular model to use in various machine learning applications. Mainly appearing in banking, stock market, e-commerce, and the medical field.

### C. Deep Neural Network (DNN)

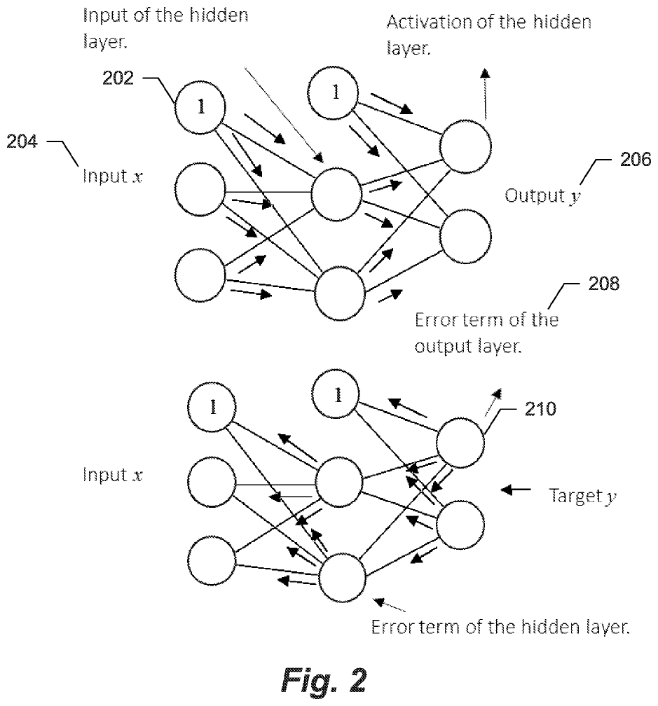

The discovery of layering and connecting of multiple networks resulted in what is now called deep learning. In particular, embodiments may utilize an application of deep learning known as Deep Neural Networks (DNN), which is composed of many connected layers of neural networks. The process of forward propagation may be used to calculate the output of the DNN. An exemplary illustration of the learning procedure is shown in FIG. 2:

Starting at the input layer, the model 202 may forward propagate the patterns of the training data 204 through the network to generate an output 206.

Based on the network's output, minimizing the error 208 may be calculated using a cost function.

Backpropagation may be used to determine the error, finding its derivative with respect to each weight in the network, and updating the model 210.

Running through multiple epochs may be used to evaluate the weights of the learning model. Forward propagation may be used to calculate the network output 206 and then backpropagation may be applied to obtain the predicted class labels.

In embodiments, the DNN may identify an anomaly score from the feature vectors for a given IoT device's network. This model may not utilize a time-based approach, and instead may compare the network data over one device simultaneously. The model may receive a series of T feature vectors for a device d and may produce a series of T hidden state vectors. The final hidden state of the DNN may be a function of the feature vectors as follows:

z_{l,t}^{d}=α(Wₗz_{l-1,t}^{d}+bₜ). (12)

Here α is a non-linear activation function, typically ReLU, tanh, or the logistic sigmoid. The tunable parameters are the weight matrices (W) and bias vectors (b).

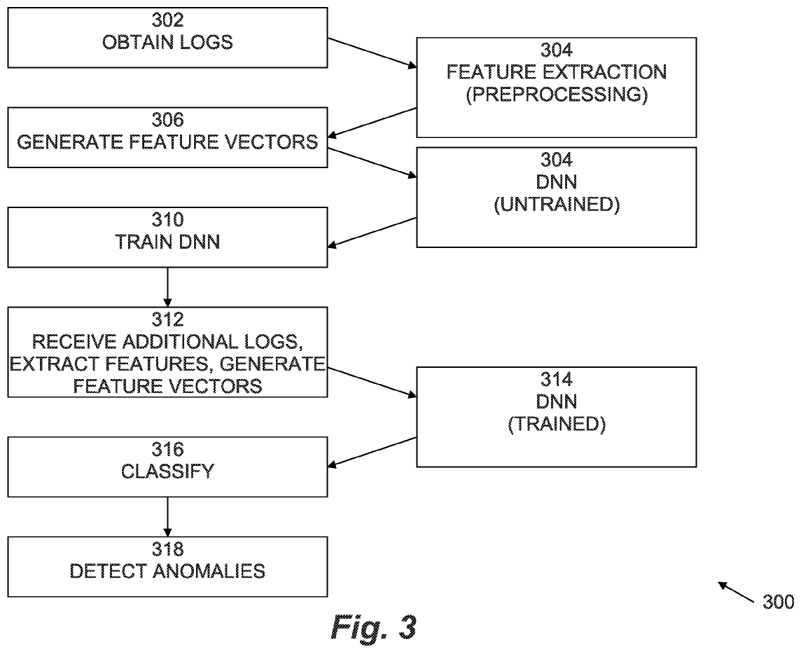

An exemplary process 300 of anomalous network traffic detection of the present systems and methods is shown in FIG. 3. Process 300 may begin with raw events from network system device logs being obtained 302. Such logs may be obtained, for example, as shown in FIG. 1, by monitoring operation of a network, such as an IoT network 100, and recording some or all of the network traffic therein. The obtained network system device logs may be fed into a feature extraction system 304, which may perform preprocessing of the raw event data prior to the machine learning model training and may configure the data into identifiable feature vectors. For example, feature extraction system 304 may extract network traffic-related features such as protocol information, such as protocol type (TCP, UDP, etc.), message type, message addresses (IP address, MAC address, etc.), etc., for captured traffic. Process 300 may be run on any network traffic protocol, or any mixture or combination of network traffic protocols.

Feature extraction system 304 may extract statistics-related features, such as correlations between two or more traffic streams, covariance between two or more traffic streams (host/destination), root squared sum of two or more variances of traffic streams (host/destination addresses), root squared sum of two or more means of traffic streams (based on host/destination addresses), standard deviation of packet size, mean deviation of packet size (received and transmitted), etc. Feature extraction system 304 may extract timing-related features, such as the time between repeated messages of various types, the time between request messages and response messages, etc. (such as 100 ms, 500 ms, 1.5 s, 10 s, 1 minute, etc.). Typically, statistical features are network agnostic, and so not dependent on the network traffic-related features.

A device's set of feature vectors 306 may then be fed into a machine learning model, such as DNN 308, which may be trained 310 to minimize the anomaly score through backpropagation. Before and during training, DNN 308 may be subject to hyper-parameter tuning to determine improved or even optimum settings for machine learning model on IoT specific applications and data. For example, hyper-parameters that may be tuned may include the number of hidden layers in DNN 308 (for example, one hidden layer, but may be, for example, one to ten hidden layers), the dimensions of the hidden layers (for example, 20 dimensions, but may be, for example, 20-500 dimensions), the batch sizes for DNN training, (for example, 64 bits, but may be, for example, 32 bits-512 bits), the number of features to be included in the DNN, such as those listed above (for example, 115 features, but may be, for example, 1-115 features), the learning rate, the number of time steps to back propagate, etc.

At 312, additional logs, for example, from continued operation of the network, may be received, features extracted, and feature vectors generated. The trained DNN 314 may be tasked with classifying 316 the additional samples with the classification values gathered from minimizing the loss equation from the training data. Although the DNN basically learns from the device's “normal” behavior, the algorithm may be unsupervised since no prior knowledge of the network is introduced. An anomaly may be proportional to the prediction error with sufficiently anomalous behavior being flagged 318.

One practical consideration embodiments may address is the transformation of network logs from original, raw format into numeric features passed as inputs. The IoT network traffic may be captured and broken down into categorical network parameters per device, for example, as listed in Table 1. Statistical parameters may be collected for each stream aggregation feature over a plurality of distinct sample collection times.

For each device d, for each time period, t, the parametric values and activity counts may be exported into a, for example, 115-dimension numeric feature vector 306. The anomaly score may be defined as the following:

\hat{α}ₜ^{d}=−logP_{θ}(xₜ^{d}|hₜ^{d}) (13)

where \hat{α}ₜ^{d} is the anomaly score associated with the probability P_{θ}, input, xₜ^{d}, and hidden vector, hₜ^{d}. When processing the network data, this model will allow the process to quantize the probability and assign an anomaly score to the current sample to detect anomalies 318. If xₜ^{d} is anomalous, then the algorithm is unlikely to assign the sample with a large probability density distribution, delivering a more narrow and higher loss value.

The anomaly scores may start out at a maximum, where the untrained model 304 knows nothing about normal behavior and decreases over time when normal behavior patterns are learned. As each anomaly score is detected, an estimate of the exponentially weighted moving average of the mean and variance may be computed and standardized. This is then used to properly place an anomaly score for device d at time t. The real-time method of DNN allows for the flexibility of immediately reacting to detected anomalous behavior 318.

In embodiments, machine learning models, such as the one-class support vector machine (SVM), random forest, and/or DNN may be used. Scikit-learn may be used for the implementation of the SVM and random forest, as both included as part of scikit-learn's package and outlier detection functionality.

### A. Training and Test Data

The machine learning models may be trained on statistical features extracted from benign network traffic data. The raw network traffic data may be captured using port mirroring on a network switch. The IoT network traffic may be collected immediately following the device's connection into the network. The network traffic collection may be summarized as: network traffic originated from a known IP address, all network sources originated from the same sources of MAC and IP addresses, known data may be transmitted between the source and destination IP addresses, and destination TCP/UDP/IP port information may be collected,

TABLE 1
Identified Parameters

| Data | Feature | |
|---|---|---|
| Features | Header | Definition of Feature |
| Stream | H | Source IP |
| Aggregation | | Stats summarizing the recent traffic from this packet's host (IP) |
| | MI | Source MAC-IP addresses |
| | | Stats summarizing the recent traffic from this packet's host (IP + MAC) |
| | HH | Channel size |
| | | Stats summarizing changes to traffic going from this packet's host IP |
| | | to the packet's destination IP |
| | HH_jit | Channel size jitter |
| | | Stats summarizing changes in channel size of traffic leaving from this |
| | | packet's host IP to the packet's destination IP |
| | HPHP | Port |
| | | Stats summarizing the recent traffic leaving from this packet's host |
| | | IP + port to the packet's destination IP + port. |
| | | ex. 192.168.4.2:1242 −> 192.168.4.12:80 |
| Statistics | mean | The mean deviation of the transmitted packet size |
| | std | The standard deviation of the packet size |
| | number | The number of items observed in recent history |
| | magnitude | The root squared sum of the two streams' means (host vs. destination addresses) |
| | radius | The root squared sum of the two streams' variances (host vs. destination addresses) |
| | covariance | An approximated covariance between two streams (host vs. destination) |
| | correlation | An approximated correlation coefficient between two streams |
| | coefficient | |
| Time Frame | L5-L0.01 | The decay factor Lambda used in the damped window |
| | | Recent history of the stream is captured in these statistics |

For example, the set of 23 features shown in Table 2 were extracted from each of five time-windows: 100 ms, 500 ms, 1.5 sec, 10 sec, and 1 min increments, totaling 115 features. These features may be computed quickly and incrementally to allow real time detection of malicious packets. Table 2 also illustrates the range of statistical values of the normal network traffic features over the longest sample collection time window (1 minute). These features are useful for capturing source IP spoofing and other key malware exploits. For example, when a compromised IoT device spoofs an IP address, the features aggregated by the source MAC/IP (feature variable MI) and IP/channel (feature variable HP) may immediately indicate a large anomaly score due to the behavior originating from the spoofed IP address.

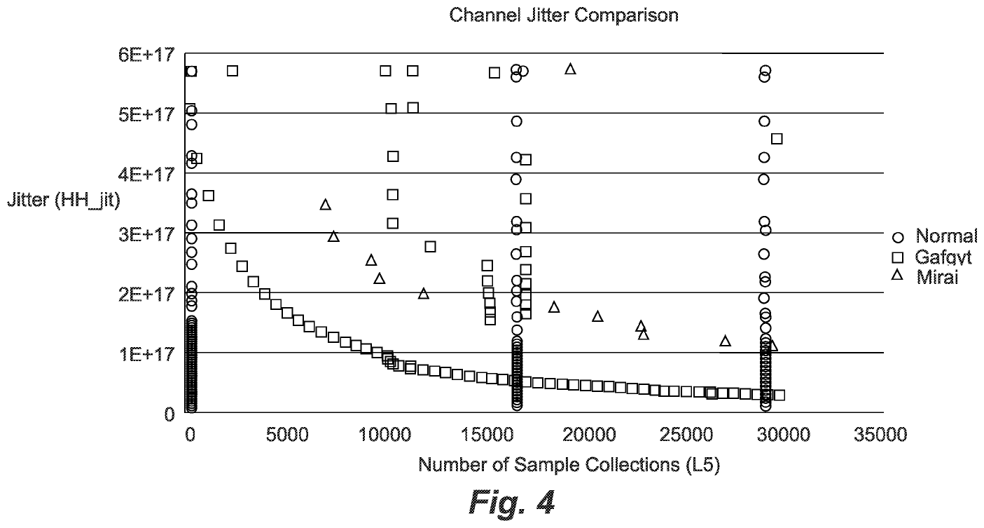

Understanding the data assists to determine if a machine learning model would be useful if applied to classifying data a classifier algorithm to a dataset. FIG. 4 shows overlaid data features between normal traffic and malicious attack traffic. This shows no direct correlation between the data features. The data for the IoT traffic cannot be determined by simply comparing a correlation between the normal and attack traffic. In addition to network features, the types of attacks are important indicators for the defending against malware attacks. For example, attack methods executed and tested may include:

Gafgyt Attacks:
1. Scan: Scanning the network for vulnerable devices
2. Junk: Sending spam data
3. UDP: UDP flooding
4. TCP: TCP flooding
5. COMBO: Sending spam data and opening a connection to a specified IP address and port

Mirai Attacks:
1. Scan: Automatic scanning for vulnerable devices
2. Ack: Ack flooding
3. Syn: Syn flooding
4. UDP: UDP flooding
5. UDP plain: UDP flooding with fewer options, optimized for higher PPS

### B. Tuning of the Machine Learning Models

Embodiments may utilize manual tuning of the machine learning models. For example, the training and test dataset sizes may be tuned such that they represent different realistic environments. For the DNN, the number of hidden layers may be tuned, for example, between 1 and 10. The hidden layer dimension may be tuned, for example, between 20 and 500, and various sizes of mini-batches may also be tested to determine best size for each malware. Additionally, the .JSON configuration file for the DNN may be tuned to be made compatible with the 115 features. The SVM and random forest machine learning models may also be tuned. For the SVM, a linear kernel may be determined to be the best fit option for classification. The SVM utilizes a random number generator when shuffling the data for probability estimates. For the random forest, the number of estimators may be tuned for optimization between 20 and 100. The max feature hyper-parameter may be fixed at the default of ‘auto’ which uses a typical number of features. Additionally, the percentage of the data the models were trained and tested on may be tuned. for example, results from the models may be trained on 5% of the dataset and tested on the remaining 95% of the dataset.

TABLE 2
Statistical Parameters Collected from the Data Features

| Statistics | HH | HH_jit | MI | H | HPHP |
|---|---|---|---|---|---|
| Mean | 330.46 | 1.56E+9 | 300.45 | 300.45 | 300.45 |
| STD | 145.71 | 5.66E+17 | 2.12E+4 | 2.12E+4 | 71.57 |
| Number | 2.01 | 2.01 | 7.73 | 7.73 | 2.01 |
| Magnitude | 555.97 | — | — | — | 300.45 |
| Radius | 6.91E+4 | — | — | — | 1.16E+4 |
| Covariance | 5355.09 | — | — | — | 5372.24 |
| Correlation | 0.97 | — | — | — | 0.78 |
| Coefficient | | | | | |
| Number of | 7 | 3 | 3 | 3 | 7 |
| Features | | | | | |

The results of experimental testing are divided between Gafgyt and the Mirai datasets. The results show that the DNN gives greater determination statistics, compared to the supervised algorithms performing on the same data. The DNN also allows for a nearly autonomous solution that is robust enough to handle new threats as they emerge. In contrast, the other tested machine learning algorithms cannot handle new types of network attacks on the fly. Since the DNN utilized mini-batches for the data parsing, the confusion matrix will show 1/64 (318 test samples) sample sizes of the SVM and random forest tests.

### A. Results

The following analyses are broken up into their respective sets of data. First the Gafgyt malware is discussed, followed by the Mirai malware.

### i. Gafgyt Malware

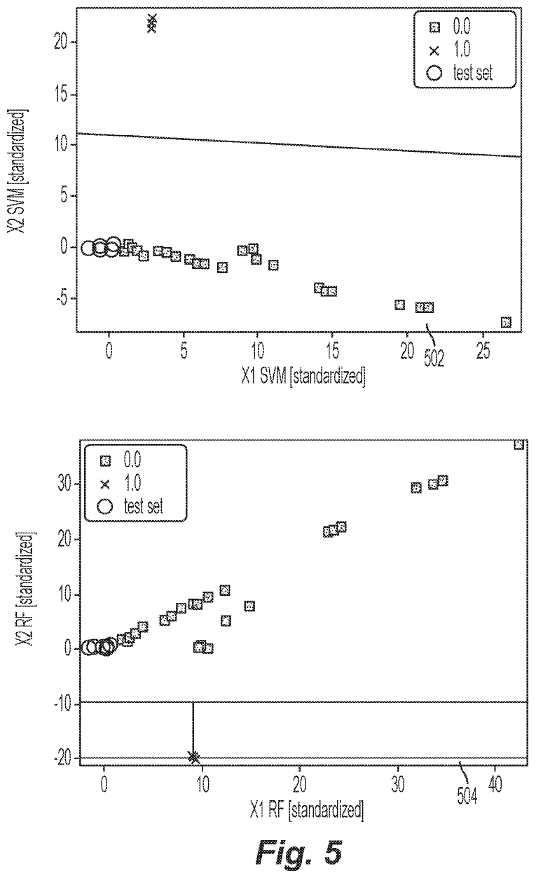

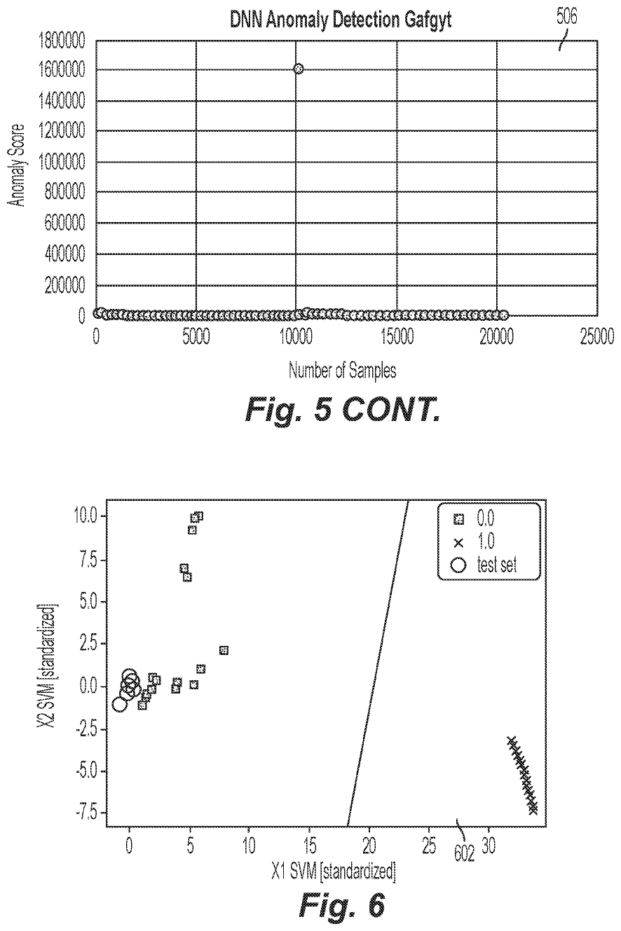

The statistical performances of test data from the Gafgyt malware is shown in Table 3, and FIG. 5 illustrates how the algorithms' classifiers performed on the Gafgyt dataset. FIG. 5 shows visualizations of the SVM performance 502, Random Forest performance 504, and DNN performance 506 performing binary classification of the Gafgyt network data. The dataset's dimension was reduced to be able to visualize the classifications. The coefficient of determination is denoted R² and is the fraction of response variances of the feature values captured by the model. This value is defined as follows:

TABLE 3
Statistical Results from the Gafgyt Test Data

| ${R}^{2} = 1 - \frac{SSE}{SST} .$ | | | | (14) |
|---|---|---|---|---|
| Algorithm | SVM | RF | DNN | |
| R2 | 0.6995 | 0.8263 | 0.9998 | |
| MSE | 0.0005 | 0.0003 | 0.0002 | |
| Accuracy | 99% | 99% | 99% | |

Here SSE is the sum of squares for the residuals, and SST is the total sum of squares. These values are the most common way of denoting results based on probabilistic outcomes. The mean square error (MSE) is a measure that expresses the minimized cost of fitting the machine learning models to the dataset. The mathematical formula of MSE is given by the following:

$$MSE = \frac{1}{n} {\sum }_{i = 1}^{n} {( {y}^{( i )} - {\hat{y}}^{( i )} )}^{2} . \qquad ( 15 )$$

Analytically, the accuracy is defined by the following:

$$Accuracy = \frac{TN + TP}{TN + TP + FN + FP} . \qquad ( 16 )$$

Where TN stand for True Negative, TP for True Positive, FN for False Negative and FP for False Positive. Table 4 shows that the SVM, random forest and DNN were each able to correctly classify 99% of the network traffic. This high accuracy further enforces the notion of generally using machine learning algorithm to detect anomalous network behavior.

### ii. Mirai Malware

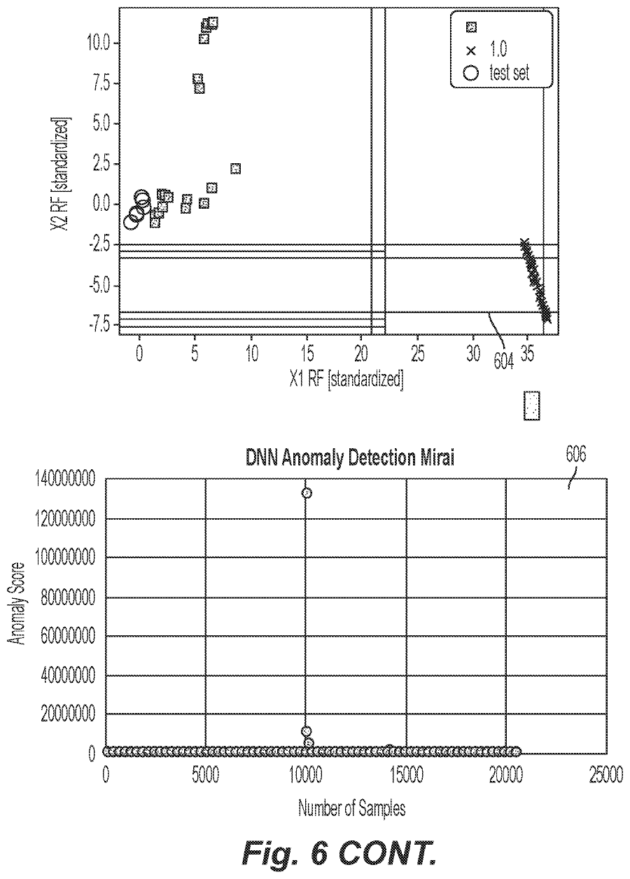

Detection of the Mirai and Gafgyt malwares largely showed similar results. The statistical performances are shown in Table 4 and the algorithms' classifiers performance are shown in FIG. 6. FIG. 6 shows visualizations of the SVM performance 602, Random Forest performance 604, and DNN performance 606 performing binary classification of the Mirai network data. Here the differences between the Mirai and the Gafgyt datasets are that the SVM and random forest each scored a lower coefficient of determinations and mean square errors. Again, all three of the algorithms scored 99% accuracy, despite decreasing statistical parameters.

TABLE 4
Statistical Results from the Mirai Test Data

| Algorithm | SVM | RF | DNN |
|---|---|---|---|
| R2 | 0.6328 | 0.7689 | 0.9968 |
| MSE | 0.0006 | 0.0004 | 0.0001 |
| Accuracy | 99% | 99% | 99% |

In this section we will dive into the implications based on the obtained results. Each of the machine learning models scored a high accuracy. This implies a heavy dependence on one of the features of the network traffic data. Based on the corresponding coefficient of determination values the DNN is the superior algorithm. Since the algorithm received a high value, this shows how the DNN was able to learn a correlated regression model and apply it to the tested data. This is suspected to have resulted from the 10-layers of neural networks the algorithm is built upon.

The DNN also had higher true negative rates, which means that the algorithm is superior for this network security application, with the notion we would rather be safe than sorry. The logistics for a deployable application requires an unsupervised approach due to environmental constraints such as network bandwidth and need for autonomy, both of which the DNN alleviate. For the supervised algorithms to persist under these constraints, additional techniques would have to be applied or an analyst would have to be present.

The channel jitter is observed to be the heaviest weighted feature by means of largest data value separations. This feature quantifies the variable network rates at which the traffic travels. This means that the DNN learned the most from the established network channel.

Scalability is crucial for this research to be applied in a real-world environment. All three of these machine learning algorithms are scalable in their own respect, however the results from the DNN show that this model has the ability to provide the most value for its installation. Since large networks of IoT devices are prone to targeted DDoS attacks, the final application would require the ability to distinguish many devices. With the DNN's proven performance on a single device, it would need supplementary work to distinguish n number of IoT devices in a network.

### VI. Conclusion

This research has discussed the backgrounds and importance of securing the IoT. Experimentation and results are walked through, depicting a solution to a lack of research in IoT networks. Future work and research areas are discussed in the following paragraphs.

Autonomy is a requirement for the application of a machine learning model to be valuable. Future work is needed in the field of artificial intelligence to provide a fully autonomous solution to network security. To further robustness, continuous monitoring is required along with adaptive decision making. These challenges may be addressed with the assistance of Software Defined Networking (SDN) which can effectively handle the security threats to the IoT devices in dynamic and adaptive manner without any burden on the IoT devices. An SDN-based secure IoT framework called SoftThings has proposed the ability to detect abnormal behaviors and attacks as early as possible and mitigate as appropriate. Machine learning was demonstrated to be used at the SDN controller to monitor and learn the behavior of IoT devices over time. Another option is utilizing a cloud deployable application. Since the cloud has the ability to remotely process and perform computations on large amounts of data, this is perfect for the DNN. Applications of a commercial cloud deployable application for IoT security is seen with Zingbox's Guardian IoT. Similar to this research, Zingbox's application employs deep learning to provide network monitoring of IoT devices.

Determining the distinct feature will be an important key to running a robust algorithm. With the commercial sights on machine learning, a thorough analysis on the feature engineering will be useful to analyze how secure this application may be. At DEFCON 24 researchers have shown that there are inherent weaknesses to the machine learning algorithms in use today. Additionally, researchers in have exploited TensorFlow's machine learning algorithms using knowledge of the Linux operating system. The understanding of the proposed future work will be crucial in furthering the success of utilizing machine learning for network security.

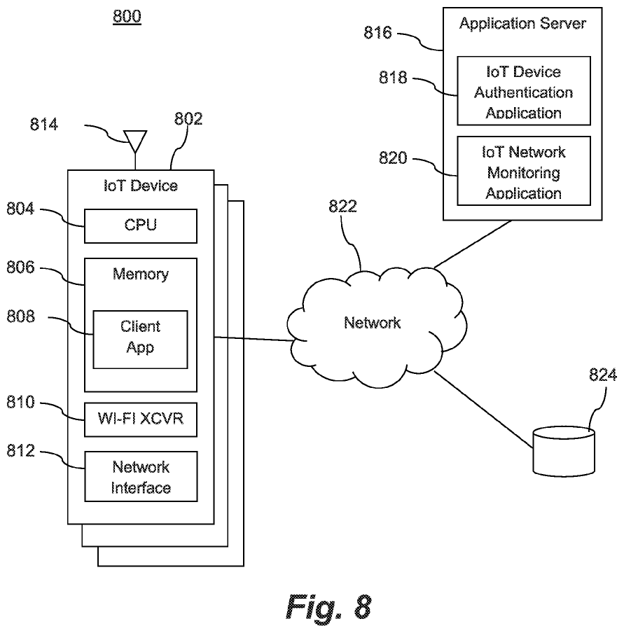

In FIG. 8, an exemplary network system 800 including IoT devices is shown. In an embodiment, the system 800 comprises an IoT wireless communication module (e.g., an IoT device) 802. The IoT device 802 comprises a processor 804, a memory 806, a client application 808 within the memory 806, a WI-FI transceiver 810, and a network interface 812. A portion of the memory 806 may be a non-transitory memory and a portion of the memory 806 may be a transitory memory. The IoT device 802 may be able to establish a wireless communication link to a network 822 using the WI-FI transceiver 810 and/or the network interface 112. The network 822 is one or more public networks, one or more private networks, or a combination thereof. The IoT device 802 communicates via the network 822 to an application server 816 communicatively coupled to the network 822. The application server 816 comprises an IoT device authentication application 818 and an IoT network monitoring application 820, both of which execute on the server 816. Communication between the IoT device 802 and the IoT network monitoring application 820 allows the IoT device 802 to perform a communication service for a user.

The network interface 812 may be able to establish wireless communication with the network 822 via the antenna 814 based on an Institute of Electrical and Electronics Engineering (IEEE) 802.11 WI-FI protocol, an Open Systems Interconnection (OSI) model layer protocol, a custom protocol, and/or the like. Although IEEE 802.11 is the standard protocol used for IoT communications, it is noted other types of protocols may be used in various settings. For example, an industrial plant might develop a custom protocol specifically for an industrial IoT to allow machine-to-machine communication, which standard IEEE 802.11 WI-FI protocol lacks.

In an embodiment, a user powers up the IoT device 802. Upon power up, the CPU 804 and memory 806 will begin running device tests to determine the functionality of the IoT device 802 is operating properly. Once the IoT device 802 is powered up and working properly, the WI-FI transceiver 810 in the IoT device 802 will send signals to the antenna 814 to identify, and communicate with, a network 822. Where the network 822 may be a local home network of the user, an industrial plant WI-FI router, and/or the like. When the IoT device 802 finds the network 822, the network interface 812 establishes network connectivity between the IoT device 802 and the network 822. The signals from the antenna 814 comprise heading information, device identifiers, and/or other protocol specific information the network 822 may need to establish a connection for the IoT device 802. In an embodiment, the signals may carry information specific to the IoT device 802, which may not conform to a typical protocol currently used in device communications. The application server 816 identifies the network 822 based on the user subscribing for a security service provided by the application server 816. For example, the user purchases cloud-based product which may be in the form of software as a service (SaaS), platform as a service (PaaS), and/or infrastructure as a service (IaaS). The application server 816 initializes the IoT authentication application 818 which accesses the database 824 to either verify a subscription exists for the network 822 or allocate space in the database 824 to queue the network 822 to be monitored by the application server 816. The application server 816 runs the IoT network monitoring application 820 comprising a machine learning algorithm to monitor the network 822 and the IoT device 802. The machine learning algorithm may be a deep neural network trained to determine a normal network traffic flow based on the network 822. For example, the deep neural network may obtain network traffic of the network 822 and modify particular parameters of the deep neural network which are unique to the network 822. The particular parameters may be the number of hidden layers in the deep neural network, the dimensions of the hidden layers, the batch size of the network traffic of which the deep neural network monitors, the features of which the deep neural network trains, a number of features included in the deep neural network model, a learning rate of the deep neural network model, and number of time steps to back propagate in the deep neural network model, and/or the like. The IoT network monitoring application 820 determines whether the network traffic is either normal or hazardous based on the trained machine learning algorithm running in the IoT network monitoring application 820. Typical use of the IoT device 802 will allow the IoT network monitoring application 820 to determine the network traffic is normal. However, when hazardous network traffic attempts to infect the IoT device 802 through the network 822 where the IoT device 802 is located, the IoT network monitoring application 820 identifies potential risk based on the hazardous network traffic having an anomaly score higher than the normal network traffic threshold. The network traffic threshold is based on the machine learning algorithm in the IoT network monitoring application 820 having trained on substantial amount of data to determine what types of network traffic are potentially hazardous. If the IoT network monitoring application 820 identifies the hazardous network traffic, then the IoT network monitoring application 820 notifies the user of the hazardous network traffic. In an alternate embodiment, the IoT network monitoring application 820 may autonomously halt all network connectivity to the IoT device 802 which the hazardous network traffic attempts to infect. For example, if a resident IT staff member at a hospital receives a notification about the IoT device 802 being infected with hazardous network traffic, then the IT staff member can provide more secure firewall settings to the network 822 where the IoT device 802 is located and reset the IoT device 822 to modify the username and password of the device before another hazardous network traffic attempts to enter the local network where the IoT device is located.

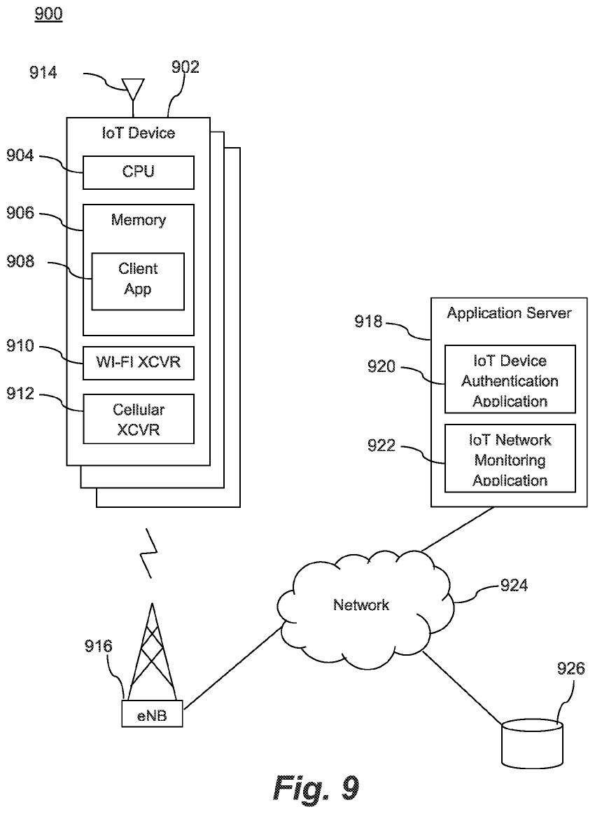

In FIG. 9, an exemplary network system 900 including IoT devices is shown. In an embodiment, the system 900 comprises an IoT wireless communication module (e.g., an IoT device) 902. The IoT device 902 comprises a processor 904, a memory 906, a client application 908 within the memory 906, a WI-FI transceiver 910, and a cellular transceiver 912. A portion of the memory 906 may be a non-transitory memory and a portion of the memory 906 may be a transitory memory. When properly activated and provisioned, the IoT device 902 may be able to establish a wireless communication link to a RAN, for example to a cell site 916. The network 924 is one or more public networks, one or more private networks, or a combination thereof. The IoT device 902 communicates via the network 924 to an application server 918 communicatively coupled to the network 924. The application server 918 comprises an IoT authentication application 920 and an IoT network monitoring application 922, both of which execute on the application server 918. Communication between the IoT device 902 and the IoT network monitoring application 920 allows the IoT device 902 to perform a communication service for a user.

In an embodiment, a user powers up the IoT device 902. Upon power up, the CPU 904 and memory 906 will begin running device tests to determine IoT device functionality is operating properly. Once the IoT device 902 is powered up and working properly, the cellular transceiver 912 in the IoT device 902 will send signals to the antenna 914 to identify, and communicate with, a network 924. The cellular transceiver 912 may be able to establish wireless communication with the cell site 916 via the antenna 914 based on a 5G, a Long-Term Evolution (LTE), a code division multiple access (CDMA), or a Global System for Mobile Communications (GSM) telecommunications protocol. When the IoT device 902 finds the network 924, the cellular transceiver 912 establishes network connectivity between the IoT device 902 and the network 924. The signals from the antenna 914 comprise heading information, device identifiers, and other protocol specific information the suitable network may need to establish a connection for the IoT device 902. The application server 918 identifies the network 924 based on the user subscribing for a security service provided by the application server 918. For example, the user purchases cloud-based product which may be in the form of software as a service (SaaS), platform as a service (PaaS), and/or infrastructure as a service (IaaS). The application server 918 initializes the IoT authentication application 920 which accesses the database 926 to either verify a subscription exists for the network 924 or allocate space in the database 926 to queue the network 926 to be monitored by the application server 918. The application server 918 runs the IoT network monitoring application 922 comprising a machine learning algorithm to monitor the network 924 and the IoT device 902. The machine learning algorithm may be a deep neural network trained to determine a normal network traffic flow based on daily activity on the network 924. For example, the deep neural network may obtain network traffic of the network 924 and modify particular parameters of the deep neural network which are unique to the network 924. The particular parameters may be the number of hidden layers in the deep neural network, the dimensions of the hidden layers, the batch size of the network traffic of which the deep neural network monitors, the features of which the deep neural network trains, a number of features included in the deep neural network model, a learning rate of the deep neural network model, and number of time steps to back propagate in the deep neural network model, and/or the like. The IoT network monitoring application 922 determines whether the network traffic is either normal or hazardous based on the trained machine learning algorithm running in the IoT monitoring application 922. Typical use of the IoT device 902 will allow the IoT network monitoring application 922 to determine the network traffic is normal. However, when hazardous network traffic attempts to infect the IoT device 902 through the network 924, the IoT network monitoring application 922 identifies potential risk based on the hazardous network traffic having an anomaly score higher than the normal network traffic threshold. The network traffic threshold is based on the machine learning algorithm in the IoT network monitoring application 922 having trained on substantial amount of data to determine what types of network traffic are potentially hazardous. If the IoT network monitoring application 922 identifies the hazardous network traffic, then the IoT network monitoring application 922 notifies the user of the hazardous network traffic. In an alternate embodiment, the IoT network monitoring application 922 may autonomously halt all network connectivity to the IoT device 902 which the hazardous network traffic attempts to infect. For example, the application server 918 sends a resident IT staff member at an industrial plant hub a notification of hazardous network traffic infecting an IoT device 902, where the resident IT staff member accordingly is able to react to the hazardous network traffic.

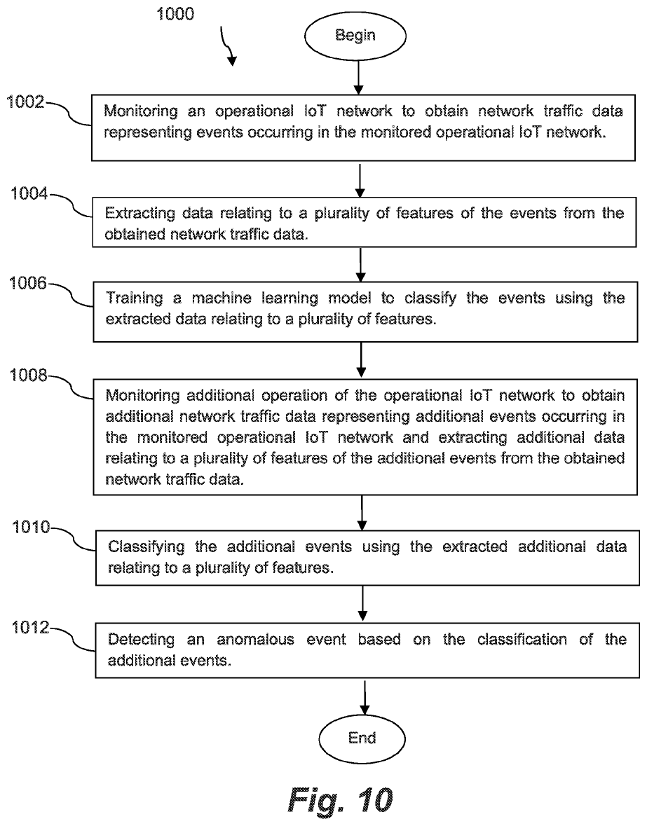

Turning now to FIG. 10, a method 1000 is described. In an embodiment, the method 1000 is a method of detecting anomalous network traffic implemented in a computer system comprising a processor, memory accessible by the processor and storing computer program instructions and data. The method 1000 may be implemented by a system similar to the system 800. At block 1002, the method 1000 comprises monitoring an operational IoT network to obtain network traffic data representing events occurring in the monitored operational IoT network.

At block 1004, the method 1000 comprises extracting data relating to a plurality of features of the events from the obtained network traffic data. At block 1006, the method 1000 comprises training a machine learning model to classify the events using the extracted data relating to a plurality of features. In an embodiment, the machine learning model comprises a deep neural network model which generates a plurality of feature vectors from the extracted data relating to a plurality of features. The hyper-parameters of the deep neural network model uniquely are tuned based on the network to which the deep neural network model is applied. For example, the hyper-parameters which require tuning are the number of hidden layers in the deep neural network, the dimensions of the hidden layers, the batch size of the network traffic of which the deep neural network monitors, the features of which the deep neural network trains, a number of features included in the deep neural network model, a learning rate of the deep neural network model, and number of time steps to back propagate in the deep neural network model, and/or the like. The deep neural network model minimizes an anomaly score through backpropagation to identify what network traffic may be hazardous to the IoT device and the network of which the IoT device is connected.

In an embodiment, the features comprise network traffic-related features, statistics-related features, and timing-related features. For example, the network traffic-related features may include protocol type, message type, and message addresses. Further, the statistics-related features may include correlation between at least two traffic streams, covariance between at least two traffic streams, root squared sum of at least two variances of traffic stream, root squared sum of at least two means of traffic streams, standard deviation of packet size, and mean deviation of packet size. Moreover, the timing-related features may include time between repeated messages, and time between request messages and response messages.

At block 1008, the method 1000 comprises monitoring additional operation of the operational IoT network to obtain additional network traffic data representing additional events occurring in the monitored operational IoT network and extracting additional data relating to a plurality of features of the additional events from the obtained network traffic data.

At block 1010, the method 1000 comprises classifying the additional events using the extracted additional data relating to a plurality of features.

At block 1012, the method 1000 comprises detecting an anomalous event based on the classification of the additional events. In an embodiment, the system notifies a user of the detected anomalous event and halts network activity to the IoT device which the system detected the anomalous event.

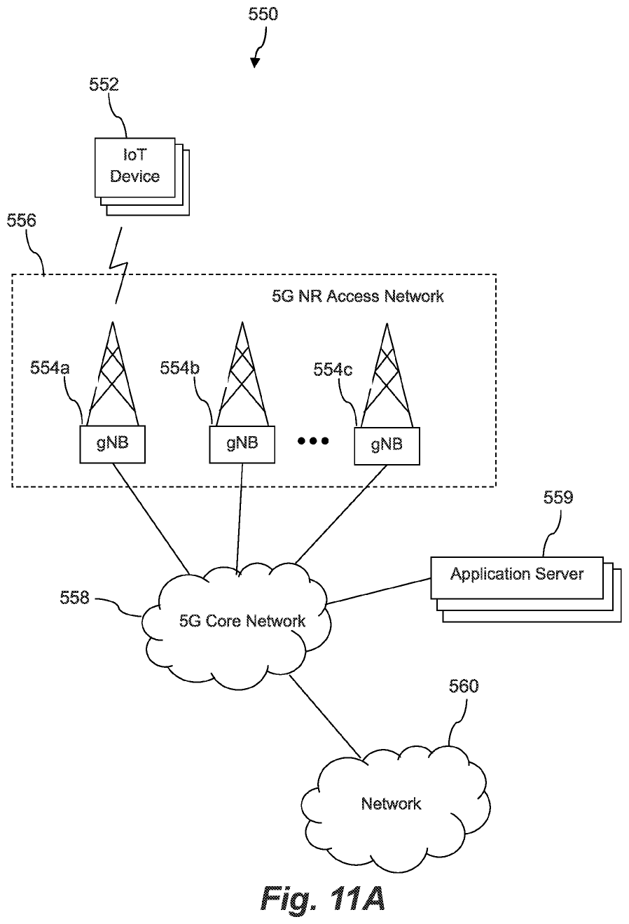

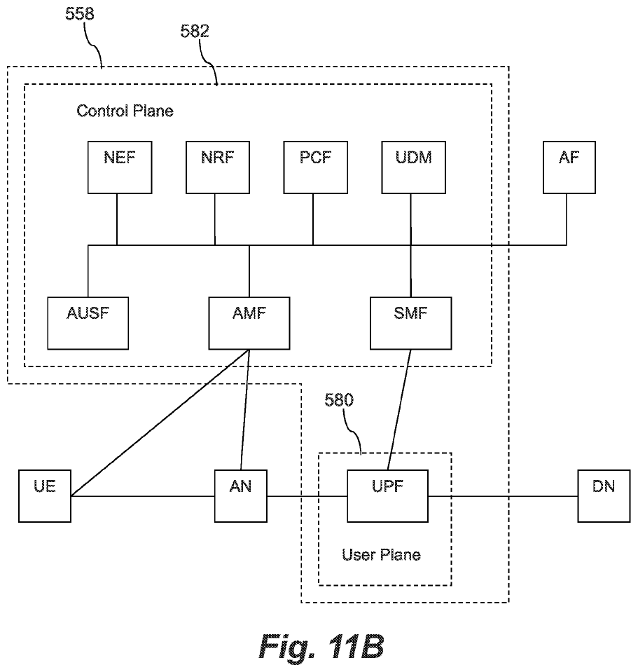

Turning now to FIG. 11A, an exemplary communication system 550 is shown. In an embodiment, at least parts of the system 800 and/or the system 900 are implemented in accordance with the system 550 described with reference to FIG. 11A and FIG. 11B. Typically the communication system 550 includes a number of access nodes 554 that are configured to provide coverage in which IoT devices 552 such as consumer IoT, industrial IoT (IIoT), medical IoT, and/or other wirelessly equipped communication devices (whether or not user operated), can operate. The access nodes 554 may be said to establish an access network 556. In a 5G technology generation an access node 554 may be referred to as a gigabit Node B (gNB). In 4G technology (e.g., long term evolution (LTE) technology) an access node 554 may be referred to as an enhanced Node B (eNB). In 3G technology (.e.g., code division multiple access (CDMA) and global system for mobile communication (GSM)) an access node 554 may be referred to as a base transceiver station (BTS) combined with a basic station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or transport networks 560, such as the public switched telephone network (PSTN) and/or the Internet for instance. With this arrangement, IoT devices 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to IoT devices 552 defining a downlink or forward link and communications from the IoT devices 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as Long Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, and/or other features, to support higher data rates and countless applications, such as mission-critical services, enhanced mobile broadband, and massive IoT. 5G is hoped to provide virtually unlimited bandwidth on demand, for example providing access on demand to as much as 10 gigabits per second (gbps) downlink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in IoT and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in RF spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and IoT devices 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served IoT devices 552.

In addition, certain resource elements on the example air interface could be reserved for special purposes. For instance, on the downlink, certain resource elements could be reserved to carry synchronization signals that IoT devices 552 could detect as an indication of the presence of coverage and to establish frame timing, other resource elements could be reserved to carry a reference signal that IoT devices 552 could measure in order to determine coverage strength, and still other resource elements could be reserved to carry other control signaling such as PRB-scheduling directives and acknowledgement messaging from the access node 554 to served IoT devices 552. And on the uplink, certain resource elements could be reserved to carry random access signaling from IoT devices 552 to the access node 554, and other resource elements could be reserved to carry other control signaling such as PRB-scheduling requests and acknowledgement signaling from IoT devices 552 to the access node 554

Turning now to FIG. 11B, further details of the core network 558 are described. In an embodiment, the core network 558 is a 5G core network. 5G core network technology is based on a service based architecture paradigm. Rather than constructing the 5G core network as a series of special purpose communication nodes (e.g., an AMF, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 574, an access and mobility management function (AMF) 576, a session management function (SMF) 577, a network exposure function (NEF), a network repository function (NRF) 571, a policy control function (PCF) 572, a unified data management (UDM) 573, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the IoT devices 552, via the access network 576, to a data network 590 (e.g., the network 560 illustrated in FIG. 11A). The AMF 576 handles registration and connection management of non-access stratum (NAS) signaling with the IoT devices 552. Said in other words, the AMF 576 manages IoT device registration and mobility issues. The AMF 576 manages reachability of the IoT devices 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 574 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. The core network 558 can provide a network slice to a subscriber, for example an enterprise customer, that is composed of a plurality of 5G network functions that are configured to provide customized communication service for that subscriber, for example to provide communication service in accordance with communication policies defined by the customer.

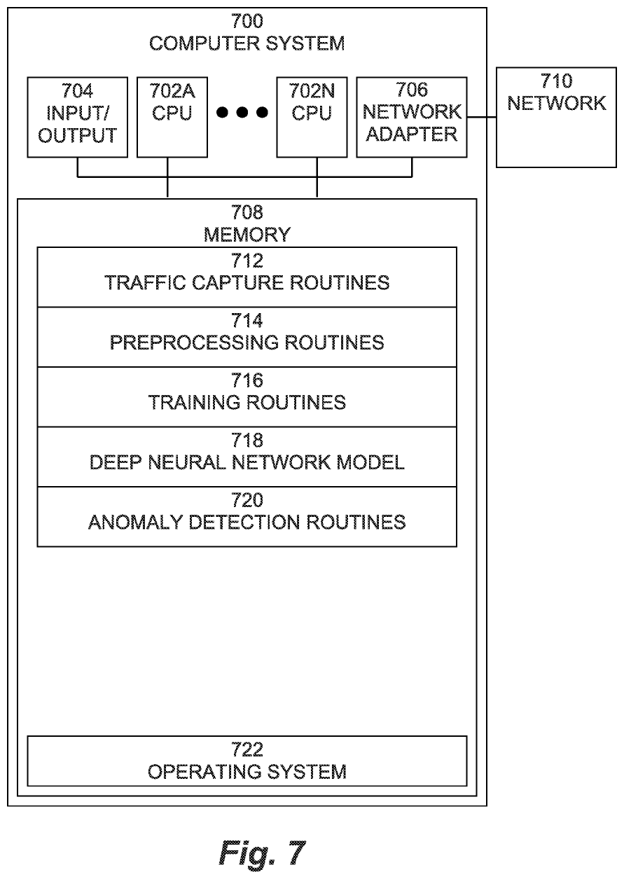

An exemplary block diagram of a computer system 700, in which processes involved in the embodiments described herein may be implemented, is shown in FIG. 7. Computer system 700 may be implemented using one or more programmed general-purpose computer systems, such as embedded processors, systems on a chip, personal computers, workstations, server systems, and minicomputers or mainframe computers, or in distributed, networked computing environments. Computer system 700 may include one or more processors (CPUs) 702A-702N, input/output circuitry 704, network adapter 706, and memory 708. CPUs 702A-702N execute program instructions in order to carry out the functions of the present communications systems and methods. Typically, CPUs 702A-702N are one or more microprocessors, such as an INTEL CORE® processor. FIG. 7 illustrates an embodiment in which computer system 700 is implemented as a single multi-processor computer system, in which multiple processors 702A-702N share system resources, such as memory 708, input/output circuitry 704, and network adapter 706. However, the present communications systems and methods also include embodiments in which computer system 700 is implemented as a plurality of networked computer systems, which may be single-processor computer systems, multi-processor computer systems, or a mix thereof.

Input/output circuitry 704 provides the capability to input data to, or output data from, computer system 700. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 706 interfaces device 700 with a network 710. Network 710 may be any public or proprietary LAN or WAN, including, but not limited to the Internet.

Memory 708 stores program instructions that are executed by, and data that are used and processed by, CPU 702 to perform the functions of computer system 700. Memory 708 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 708 may vary depending upon the function that computer system 700 is programmed to perform. In the example shown in FIG. 7, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present communications systems and methods may include any and all such arrangements.

In the example shown in FIG. 7, memory 708 may include traffic capture routines 712, preprocessing routines 714, training routines 716, deep neural network model 718, anomaly detection routines 720, and operating system 722. Traffic capture routines 712 may include software to capture network traffic in the form or raw event data, as described above. Preprocessing routines 714 may include software to preprocess raw event data prior configure the data into identifiable feature vectors, as described above. Training routines 716 may include software to train deep neural network model 718, as described above. Deep neural network model 718 may include software to perform classification of network traffic-related features, as described above. Anomaly detection routines 720 may include software to detect the occurrence of anomalies in the network traffic based on the classification of network traffic-related features, as described above. Operating system 722 may provide overall system functionality.

As shown in FIG. 7, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1-66. (canceled)

67. A method of detecting anomalous network traffic implemented in a computer system comprising a processor, memory accessible by the processor and storing computer program instructions and data, and computer program instructions to perform:
monitoring an operational IoT network to obtain network traffic data representing events occurring in the monitored operational IoT network;
extracting data relating to a plurality of features of the events from the obtained network traffic data;
training a machine learning model to classify the events using the extracted data relating to a plurality of features;
monitoring additional operation of the operational IoT network to obtain additional network traffic data representing additional events occurring in the monitored operational IoT network and extracting additional data relating to a plurality of features of the additional events from the obtained network traffic data;
classifying the additional events using the extracted additional data relating to a plurality of features; and
detecting an anomalous event based on the classification of the additional events.

68. The method of claim 67, wherein the features comprise network traffic-related features and the network traffic-related features further comprise protocol type, message type, and message addresses.

69. The method of claim 67, wherein the features comprise statistics-related features and the statistics-related features further comprise correlation between at least two traffic streams, covariance between at least two traffic streams, root squared sum of at least two variances of traffic stream, root squared sum of at least two means of traffic streams, standard deviation of packet size, and mean deviation of packet size.

70. The method of claim 67, wherein the features comprise timing-related features and the timing-related features further comprise time between repeated messages and time between request messages and response messages.

71. The method of claim 67, wherein the machine learning model comprises at least one of a support vector machine model, a random forest model, and a deep neural network model.

72. The method of claim 67, wherein the machine learning model comprises a deep neural network model and the method further comprises:
generating a plurality of feature vectors from the extracted data relating to a plurality of features.

73. The method of claim 72, wherein the deep neural network model comprises hyper-parameters that may be tuned and the hyper-parameters further comprise at least one of a number of hidden layers in the deep neural network model, dimensions of the hidden layers of the deep neural network model, batch sizes for training of the deep neural network model, a number of features included in the deep neural network model, a learning rate of the deep neural network model, and number of time steps to back propagate in the deep neural network model.

74. The method of claim 67, wherein detecting the anomalous event comprises:
determining an anomaly score; and
detecting the anomalous event when the anomaly score is greater than a threshold.

75. The method of claim 74, wherein the anomaly score comprises at least one of a prediction error or a probability of an input vector given a hidden state vector for an IoT device at a given time.

76. The method of claim 75, wherein when the anomalous event is detected, a notification may be sent to a user and the IoT device may be shut down.

77. A system for detecting anomalous network traffic comprising a processor, memory accessible by the processor, and computer program instructions stored in the memory and executable by the processor to perform:
monitoring an operational IoT network to obtain network traffic data representing events occurring in the monitored operational IoT network;
extracting data relating to a plurality of features of the events from the obtained network traffic data;
training a machine learning model to classify the events using the extracted data relating to a plurality of features;
monitoring additional operation of the operational IoT network to obtain additional network traffic data representing additional events occurring in the monitored operational IoT network and extracting additional data relating to a plurality of features of the additional events from the obtained network traffic data;
classifying the additional events using the extracted additional data relating to a plurality of features; and
detecting an anomalous event based on the classification of the additional events.

78. The system of claim 77, wherein the features comprise network traffic-related features and the network traffic-related features further comprise protocol type, message type, and message addresses.

79. The system of claim 77, wherein the features comprise statistics-related features and the statistics-related features further comprise correlation between at least two traffic streams, covariance between at least two traffic streams, root squared sum of at least two variances of traffic stream, root squared sum of at least two means of traffic streams, standard deviation of packet size, and mean deviation of packet size.

80. The system of claim 77, wherein the features comprise timing-related features and the timing-related features further comprise time between repeated messages and time between request messages and response messages.

81. The system of claim 77, wherein the machine learning model comprises at least one of a support vector machine model, a random forest model, and a deep neural network model.

82. The system of claim 77, wherein the machine learning model comprises a deep neural network model and the method further comprises:
generating a plurality of feature vectors from the extracted data relating to a plurality of features.

83. The system of claim 82, wherein the deep neural network model comprises hyper-parameters that may be tuned and the hyper-parameters further comprise at least one of a number of hidden layers in the deep neural network model, dimensions of the hidden layers of the deep neural network model, batch sizes for training of the deep neural network model, a number of features included in the deep neural network model, a learning rate of the deep neural network model, and number of time steps to back propagate in the deep neural network model.

84. The system of claim 77, wherein detecting the anomalous event comprises:
determining an anomaly score; and
detecting the anomalous event when the anomaly score is greater than a threshold.

85. The system of claim 84, wherein the anomaly score comprises at least one of a prediction error or a probability of an input vector given a hidden state vector for an IoT device at a given time.

86. The system of claim 85, wherein when the anomalous event is detected, a notification may be sent to a user and the IoT device may be shut down.
